(19) United States
(12) Patent Application Publication
(10) Pub. No.: US 2015/0147915 A1
(43) Pub. Date: May 28, 2015

(54) CONNECTOR

(71) Applicant: HOSIDEN CORPORATION, Yao-shi (JP)

(72) Inventor: Keiichi Taniguchi, Yao-shi (JP)

(73) Assignee: HOSIDEN CORPORATION, Yao-shi (JP)

(21) Appl. No.: 14/397,264

(22) PCT Filed: May 14, 2013
(86) PCT No.: PCT/JP2013/063414

§ 371 Date: Oct. 27, 2014

(30) Foreign Application Priority Data
May 18, 2012 (JP) 2012-114020

(51) Int. Cl. H01R 13/6461

(52) U.S. Cl. CPC H01R 13/6461
USPC 439/660

(57) ABSTRACT

The invention provides a connector capable of reducing crosstalk between contacts. The connector includes first and second contacts 200a and 200b aligned at a first height along a first direction X in a body 100, a third contact 200c provided at a second height between the first and second contacts 200a and 200b in the body 100, and fourth contacts 300a disposed at a third height other than the first and second heights, on the sides in the first direction X of the third contact 200c in the body 100. The third contact 200c includes a third body 210c (crosstalk reduction portion), and the first and second contacts 200a and 200b respectively include first and second bodies 210a and 210b (first and second corresponding portions). The third body 210c is located closer to the fourth contacts 300a than the first and second bodies 210a and 210b are.

### TECHNICAL FIELD

The present invention relates to connectors.

### BACKGROUND ART

This kind of connector is disclosed by Japanese Unexamined Patent Publication No. 2011-29174 (U.S. patent application Ser. No. 12/460,707). The connector includes an insulating body, five contacts designed for USB 3.0, and four contacts designed for USB 2.0. The USB 3.0 contacts are arranged in a line along a first direction in the body. The USB 3.0 contacts include a pair of first differential signal contacts and a pair of second differential signal contacts. The USB 2.0 contacts are arranged in a line along the first direction in the body and located below the USB 3.0 contacts. The USB 2.0 contacts include a pair of third differential signal contacts.

### CITATION LIST

### Patent Literature

Patent literature 1: Japanese Unexamined Patent Publication No. 2011-29174 (U.S. patent application Ser. No. 12/460,707)

### SUMMARY OF INVENTION

### Technical Problem

The inner contacts of the respective pairs of first and second differential signal contacts are at a small distance from the third differential signal contacts, possibly causing crosstalk between the inner first and second differential signal contacts and the third differential signal contacts.

The invention is devised in view of the above circumstances and aims to provide a connector capable of reducing crosstalk between contacts.

### Solution to Problem

To solve the above problem, the invention provides a connector including a body having an insulating property, a first contact, a second contact, a third contact, and a fourth contact. The first and second contacts serve as signal contacts being aligned at a first height along a first direction in the body. The third contact serves as a ground contact being provided at a second height between the first and second contacts in the body. The fourth contact serves as a signal contact being provided at a third height in the body to be located on one of sides in the first direction of the third contact. The third height is a different height from the first and second heights. The third contact includes a crosstalk reduction portion. The first and second contacts respectively include first and second corresponding portions corresponding to the crosstalk reduction portion. The crosstalk reduction portion is located closer to the fourth contact than the first and second corresponding portions are.

In the connector of this aspect, the crosstalk reduction portion of the third contact between the first and second contacts is located closer to the fourth contact than the first and second corresponding portions of the first and second contacts are. Accordingly, Signals leaking from the fourth contact will be absorbed by the crosstalk reduction portion of the third contact, reducing crosstalk between the first and second contacts and the fourth contact.

The first contact may include a pair of first contacts disposed next to each other at the first height along the first direction. The second contact may include a pair of second contacts disposed next to each other at the first height along the first direction. The third contact may be disposed between one of the first contacts and one of the second contacts.

The fourth contact may include a pair of fourth contacts disposed at the third height on the respective sides in the first direction of the third contact. In this case, one of the fourth contacts may be disposed at the third height between the one of the first contacts and the third contact, and the other fourth contact may be disposed at the third height between the one of the second contacts and the third contact.

The connector may further include a fifth contact and a sixth contact. The fifth contact may be provided at the third height between the first contacts in the body. The sixth contact may be provided at the third height between the second contacts in the body.

The third contact may further include a third contact portion. The third contact portion may be movable toward the fourth contacts resulting from partial elastic deformation of the third contact under an external force. Each of the first contacts and each of the second contacts may further include first and second contact portions, respectively, disposed at the same height as the third contact portion of the third contact. The first and second contact portions may be movable toward the fourth contacts resulting from partial elastic deformation of the first and second contacts under an external force. The one and other of the fourth contacts may include a fourth separated portion. The fourth separated portion of the one of the fourth contacts may be located on a moving direction side of the first and third contact portions, and the first and third contact portions may be movable toward the fourth separated portion. The fourth separated portion of the other fourth contact may be located on a moving direction side of the second and third contact portions, and the second and third contact portions may be movable toward the fourth separated portion of the other fourth contact. The fifth contact may include a fifth separated portion located on the moving direction side of the first contact portions, and the first contact portions may be movable toward the fifth separated portion. The sixth contact may include a sixth separated portion located on the moving direction side of the second contact portions, and the second contact portions may be movable toward the sixth separated portion. A distance between each of the first contact portions as moved and the fifth separated portion may be such that impedance of each of the first contacts varies in a range of 75 Ω to 105 Ω in accordance with the movement of the first, second, and third contact portions. A distance between each of the second contact portions as moved and the sixth separated portion may be such that impedance of each of the second contacts varies in a range of 75 Ω to 105 Ω in accordance with the movement of the first, second, and third contact portions.

In the connector of this aspect, when the first, second, and third contact portions move closer to the fourth, fifth, and sixth separated portions, impedance variations of the first and second contacts are suppressed to a range of 75 Ω to 105 Ω.

Alternatively, the third contact may include a third body, a third slope, a third contact portion, and a third tail. The third body may serve as the crosstalk reduction portion being held in the body and include first and second ends in a second direction. The second direction may be orthogonal to the first direction. The third slope may be contiguous with the first end of the third body and slope toward the fourth contacts. The third contact portion may be contiguous with the third slope. The third tail may be contiguous with the second end of the third body and protrude from the body. The first contacts may each include a first body, a first slope, a first contact portion, and a first tail. The first body may serve as the first corresponding portion being held in the body and include first and second ends in the second direction. The first slope may be contiguous with the first end of the first body and slope toward the fourth contacts. The first contact portion may be contiguous with the first slope and located at the same height as the third contact portion of the third contact. The first tail may be contiguous with the second end of the first body and protrude from the body. The second contacts may each include a second body, a second slope, a second contact portion, and a second tail. The second body may serve as the second corresponding portion being held in the body and include first and second ends in the second direction. The second slope may be contiguous with the first end of the second body and slope toward the fourth contacts. The second contact portion may be contiguous with the second slope and located at the same height as the third contact portion of the third contact. The second tail may be contiguous with the second end of the second body and protrude from the body.

The first, second, and third slopes may be elastically deformable toward the fourth contacts when the first, second, and third contact portions under an external three move toward the fourth contacts. The one and other of the fourth contacts may each include a fourth body, a fourth slope, a fourth separated portion, a fourth contact portion, and a fourth tail. The fourth body of the one of the fourth contacts may be held in the body and include first and second ends in the second direction. The fourth slope of the one of the fourth contacts may be contiguous with the first end of the fourth body and slope in the same direction as the first and second slopes. The fourth separated portion of the one of the fourth contacts may be contiguous with the fourth slope, extend in the second direction, and be located on the moving direction side of the first and third contact portions, and the first and third contact portions may be movable toward the fourth separated portion. The fourth contact portion of the one of the fourth contacts may be contiguous with the fourth separated portion. The fourth tail of the one of the fourth contacts may be contiguous with the second end of the fourth body and protrude from the body. The fourth body of the other fourth contact may be held in the body and include first and second ends in the second direction. The fourth slope of the other fourth contact may be contiguous with the first end of the fourth body of the other fourth contact and slope in the same direction as the first and second slopes. The fourth separated portion of the other fourth contact may be contiguous with the fourth slope of the other fourth contact, extend in the second direction, and be located on the moving direction side of the second and third contact portions, and the second and third contact portions may be movable toward the fourth separated portion of the other fourth contact. The fourth contact portion of the other fourth contact may be contiguous with the fourth separated portion of the other fourth contact. The fourth tail of the other fourth contact may be contiguous with the second end of the fourth body of the other fourth contact and protrude from the body. The fifth contact may include a fifth body, a fifth slope, a fifth separated portion, a fifth contact portion, and a fifth tail. The fifth body may be held in the body and include first and second ends in the second direction. The fifth slope may be contiguous with the first end of the fifth body and slope in the same direction as the first and second slopes. The fifth separated portion may be contiguous with the fifth slope, extend in the second direction, and be located on the moving direction side of the first contact portions, and the first contact portions may be movable toward the fifth separated portion. The fifth contact portion may be contiguous with the fifth separated portion. The fifth tail may be contiguous with the second end of the fifth body and protrude from the body. The sixth contact may include a sixth body, a sixth slope, a sixth separated portion, a sixth contact portion, and a sixth tail. The sixth body may be held in the body and include first and second ends in the second direction. The sixth slope may be contiguous with the first end of the sixth body and slope in the same direction as the first and second slopes. The sixth separated portion may be contiguous with the sixth slope, extend in the second direction, and be located on the moving direction side of the second contact portions, and the second contact portions may be movable toward the sixth separated portion. The sixth contact portion may be contiguous with the sixth separated portion. The sixth tail may be contiguous with the second end of the sixth body and protrude from the body. A distance between each of the first contact portion as moved and the fifth separated portion may be set such that impedance of each of the first contacts varies in a range of 75 Ω to 105 Ω, in accordance with the movement of the first, second, and third contact portions. A distance between each of the second contact portion as moved and the sixth separated portion may be set such that impedance of each of the second contacts varies in a range of 75 Ω, to 105 Ω in accordance with the movement of the first, second, and third contact portions.

In the connector of this aspect, when the first, second, and third contact portions move closer to the fourth, fifth, and sixth separated portions, impedance variations of the first and second contacts are suppressed to a range of 75 Ω to 105 Ω.

### BRIEF DESCRIPTION OF DRAWINGS

FIG. 1A is a schematic perspective view of a front, top, right side of a connector according to an embodiment of the invention.

FIG. 1B is a schematic perspective view of a back, bottom, right side of the connector.

FIG. 2A is a sectional view of the connector taken along 2A-2A in FIG. 1A.

FIG. 2B is a sectional view of the connector taken along 2B-2B in FIG. 1A.

FIG. 2C is a sectional view of the connector taken along 2C-2C in FIG. 1A.

FIG. 3A is a schematic perspective view of front, top, right sides of a body and first and second contact groups of the connector.

FIG. 3B is a schematic perspective view of back, bottom, right sides of the body and the first and second contact groups of the connector.

FIG. 4A is a front view of the contacts of the first and second contact groups of the connector, showing the relative positioning of the contacts.

FIG. 4B is a back view of the contacts of the first and second contact groups of the connector, showing the relative positioning of the contacts.

FIG. 4C is a right side view of the contacts of the first and second contact groups of the connector, showing the relative positioning of the contacts.

FIG. 4D is a plan view of the contacts of the first and second contact groups of the connector, showing the relative positioning of the contacts.

FIG. 4E is a bottom view of the contacts of the first and second contact groups of the connector, showing the relative positioning of the contacts.

### DESCRIPTION OF EMBODIMENTS

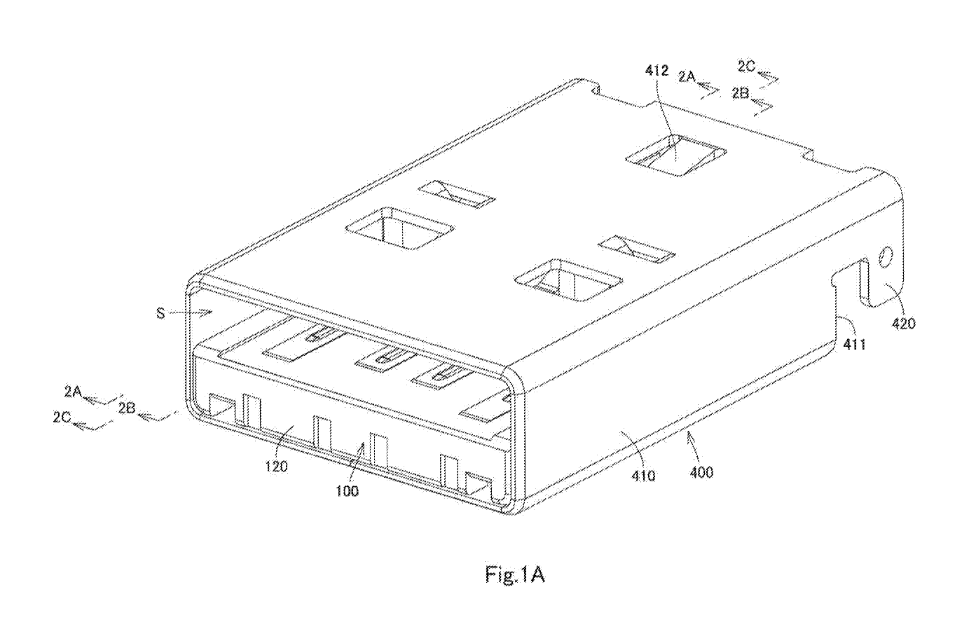

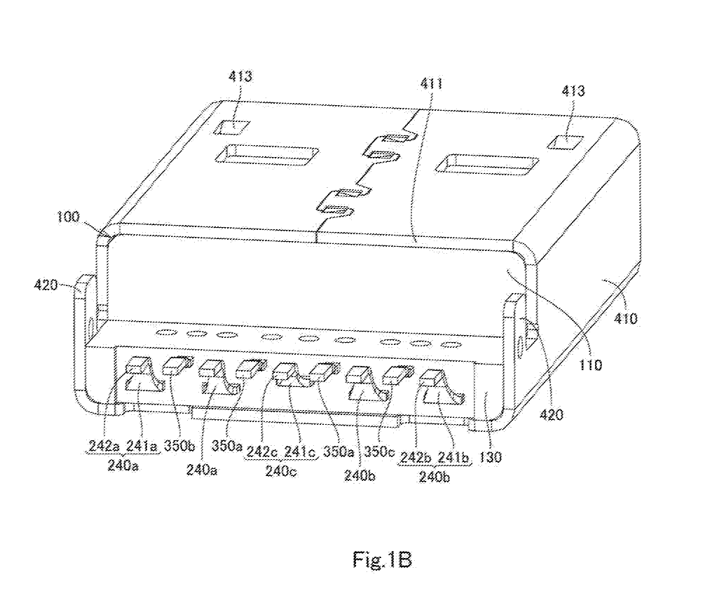

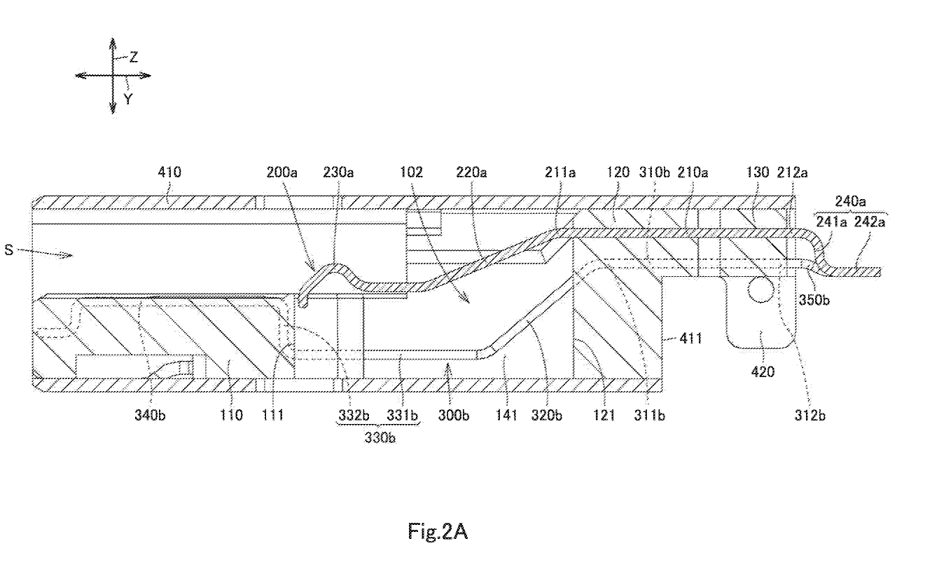

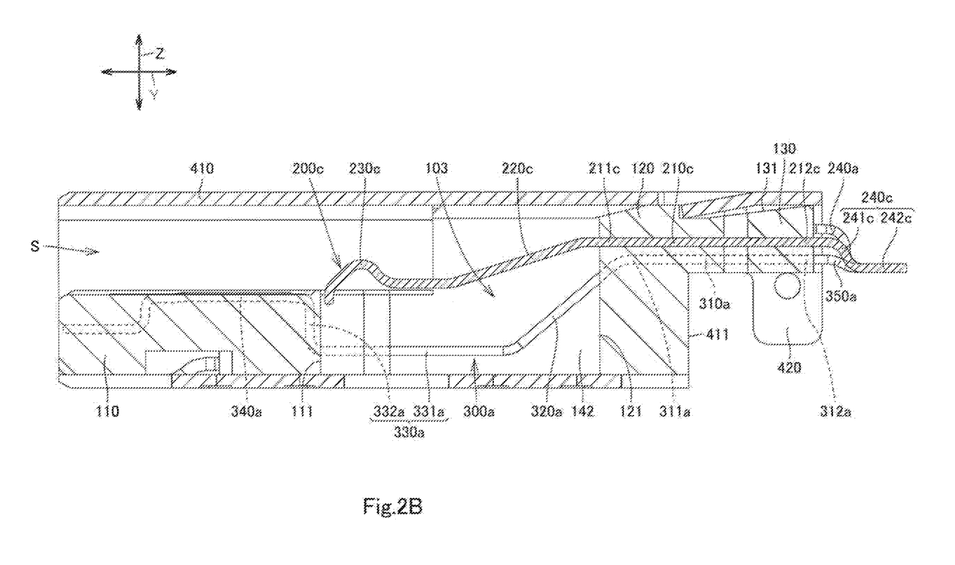

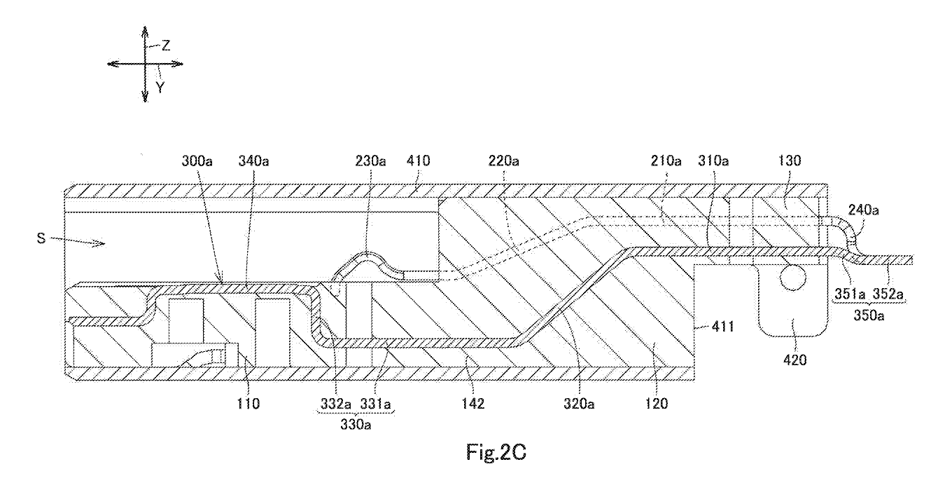

A connector according to an embodiment of the invention will be described below with reference to FIG. 1A to FIG. 4E. The connector as shown in FIG. 1A and FIG. 1B is a plug connector connectable to a cable (not shown) or a cable via a circuit board (not shown). The connector includes a body 100, a first contact group designed for USB 3.0, a second contact group designed for USB 2.0, and a shell 400. These components of the connector will be described below in detail. The first direction X as shown in FIG. 2A to FIG. 4E is the widthwise direction of the connector and the contacts of the first and second contact groups, and also the direction in which these contacts are arranged. The second direction Y as shown in FIG. 2A to FIG. 4E is the lengthwise direction of the connector and the contacts of the first and second contact groups. The third direction Z as shown in FIG. 2A to FIG. 4E is the heightwise direction of the connector, and also the thickness direction of the contacts of the first and second contact groups. The first direction X is orthogonal to the second direction Y, and the third direction Z is orthogonal to the first direction X and the second direction Y.

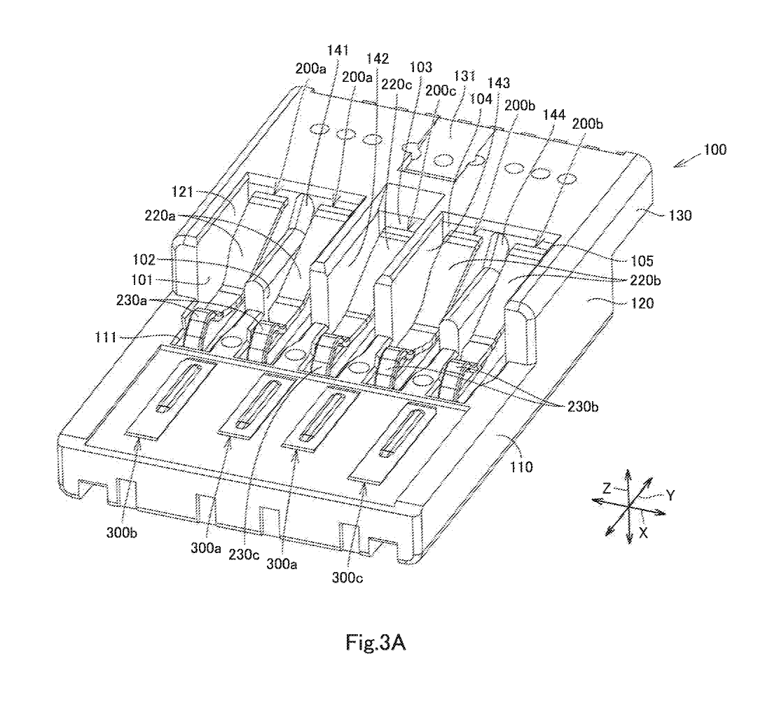

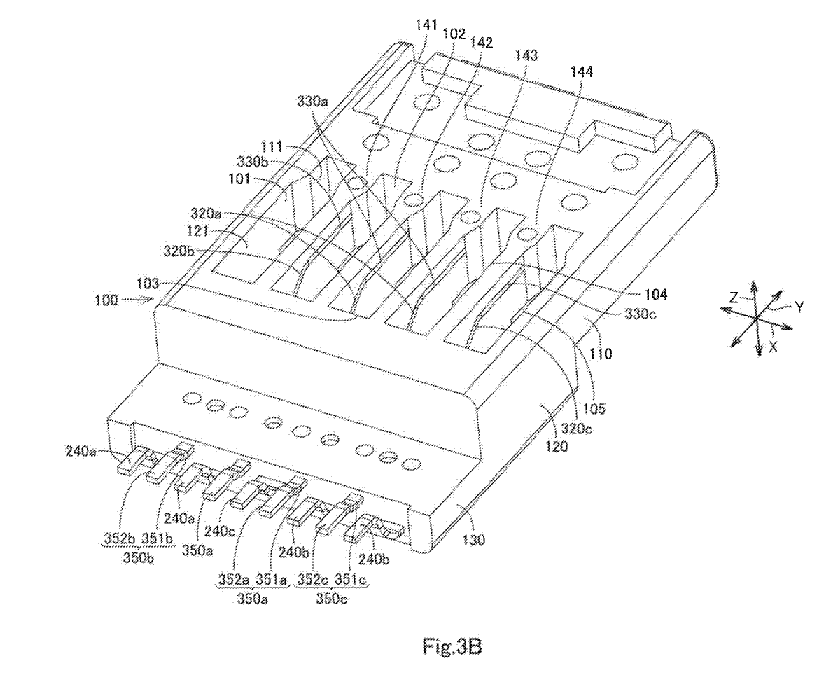

The body 100 is an insulating resin block as shown in FIG. 2A to FIG. 3B. The body 100 includes a front section 110, a middle section 120, and a rear section 130. The middle section 120 is a rectangular block. The front section 110 is a rectangular plate contiguous with a lower portion of an end face in the second direction Y (front face) of the middle section 120. The front section 110 extends to the one side in the second direction Y (frontward). The rear section 130 is a rectangular plate contiguous with an upper portion of the other end face in the second direction Y (rear face) of the middle section 120. The rear section 130 extends to the other side in the second direction Y (rearward).

The middle section 120 has a recess 121. The recess 121 passes through the middle section 120 in the third direction Z to be open at the one side in the second direction Y (front side). The front section 110 has a recess 111. The recess 111 passes through the front section 110 in the third direction Z and communicates with the recess 121 of the middle section 120. Inside the recesses 111 and 121 provided are partitions 141, 142, 143, and 144 spaced along the first direction X. The partitions 141, 142, 143, and 144 extend in the second direction Y, from a wall on the one side in the second direction Y (front side) of the recess 111 to a wall on the other side in the second direction Y (rear side) of the recess 121. The partitions 141, 142, 143, and 144 partition the inner space defined by the recesses 111 and 121 into housing spaces 101, 102, 103, 104, and 105. The upper face of the rear section 130 has an engagement recess 131. The lower face of the rear section 130 can be placed on the circuit board.

As shown in FIG. 1A to FIG. 2C, the shell 400 includes a shell body 410 and a pair of connection pieces 420. The shell body 410 is an electrically conductive plate formed into a square tube to surround the body 100. One end portion in the second direction Y of the shell body 410, and the front section 110 and the middle section 120 of the body 100 define a connection port S for fittingly receive a receptacle connector (mating connector), not shown. There is a notched space 411 in a lower portion of the other end portion in the second direction Y of the shell body 410. Through the notched space 411 exposed are the lower portion of the rear face of the middle section 120 of the body 100 and the lower face of the rear section 130 of the body 100. The top plate of the shell body 410 is provided with a first engagement piece 412. The first engagement piece 412 engages with the engagement recess 131 in the rear section 130. The bottom plate of the shell body 410 is provided with a pair of second engagement pieces 413. The second engagement pieces 413 engage with an engagement recess in the front section 110.

The connection pieces 420 hang downward from the side plates in the first direction X of the end portion of the shell body 410. The connection pieces 420 are connectable with respective through-hole ground electrodes in the circuit board.

As shown in FIG. 2A to FIG. 4E, the first contact group includes a pair of first contacts 200a, a pair of second contacts 200b, and a third contact 200c. As shown in FIG. 3A, the first, second, and third contacts are arranged in the body 100, in spaced relation along the first direction X in the following order: 200a, 200a, 200c, 200b, and 200b.

As shown in FIG. 2A to FIG. 4E, the second contact group includes a pair of fourth contacts 300a, a fifth contact 300b, and a sixth contact 300c. The fourth, fifth, and sixth contacts are arranged on one side in the third direction Z (lower side) of the first contact group (the first, second, and third contacts 200a, 200b, and 200c) in the body 100, in spaced relation along the first direction X in the following order: 300b, 300a, 300a, and 300c.

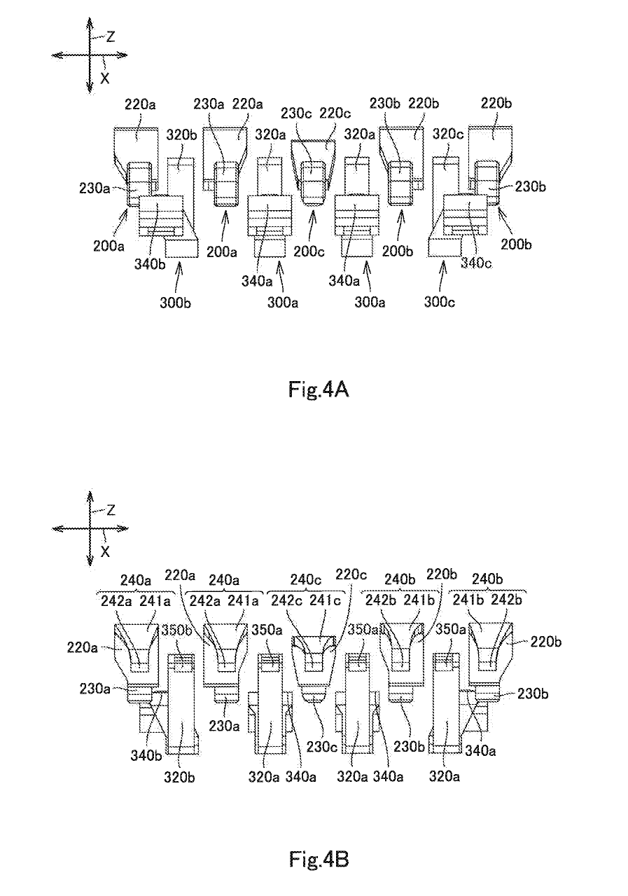

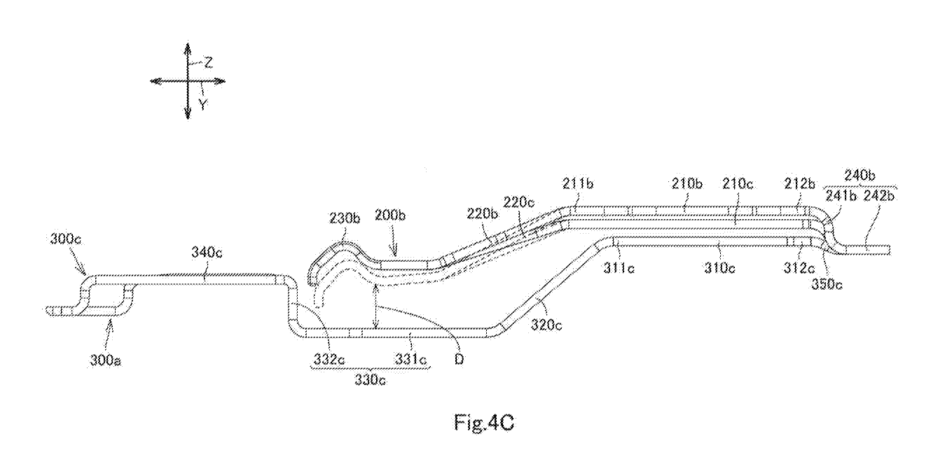

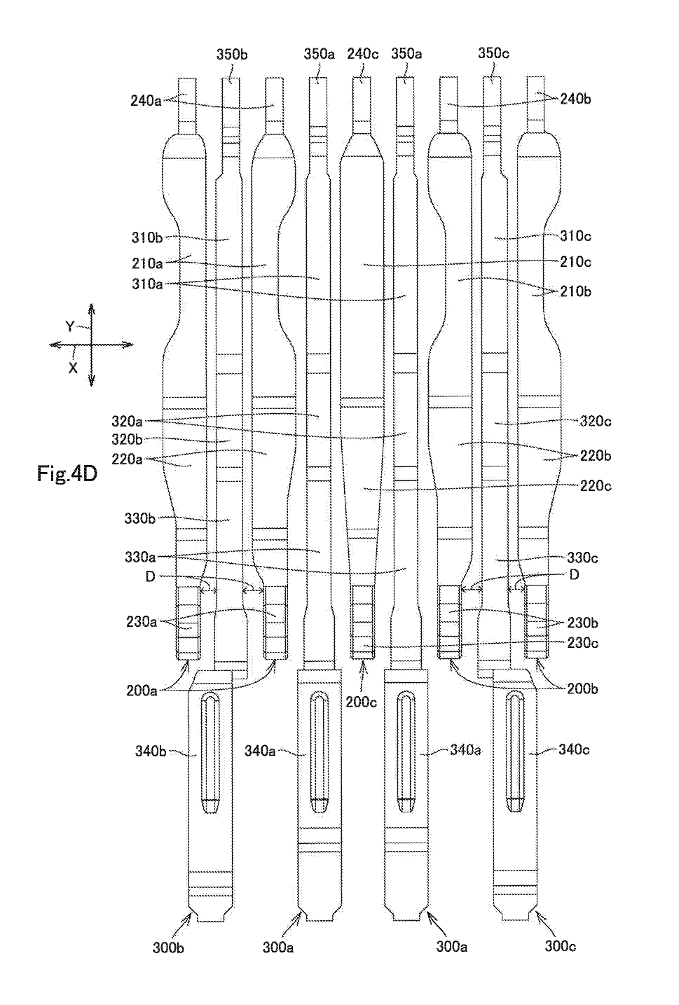

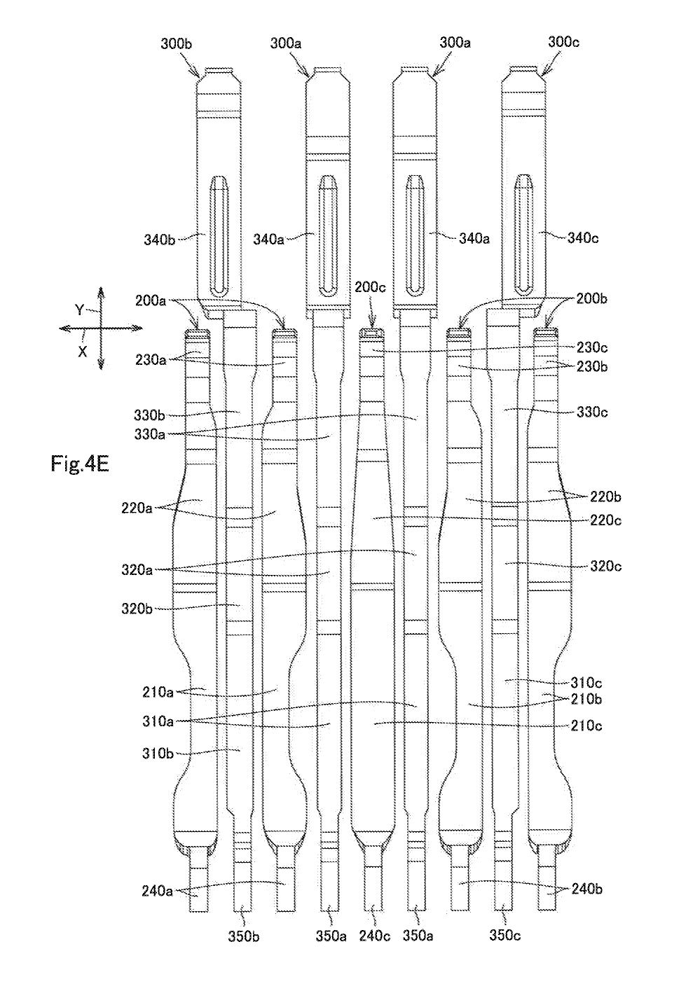

The pair of first contacts 200a are metal plates extending in the second direction Y and are mirror images of each other (see FIG. 4D and FIG. 4E). The first contacts 200a are next to each other at a first height along the first direction X. The first contacts 200a constitute a differential pair for transmitting high-speed differential signals of about 2.5 GHz. In other words, the first contacts 200a are signal contacts for differential signaling. One of the pair of first contacts 200a will be referred to as one of the first contacts 200a, and the other as the other first contact 200a.

As best shown in FIG. 2A, the first contacts 200a each have a first body 210a, a first slope 220a, a first contact portion 230a, and a first tail 240a. The first body 210a is a plate extending in the second direction Y and includes a first end 211a and a second end 212a in the second direction Y. The first body 210a is embedded in the middle section 120 and the rear section 130 of the body 100. The first end 211a of the first body 210a protrudes from the wall on the other side in the second direction Y of the recess 121 of the body 100. The first slope 220a is a plate contiguous with the first end 211a of the first body 210a to extend in the second direction Y. The first slope 220a slopes down to the one side in the third direction Z (the fourth contact 300a side). The first slope 220a of the one of the first contacts 200a is housed in the housing space 102 of the body 100. The first slope 220a of the other first contact 200a is housed in the housing space 101 of the body 100.

Each first contact portion 230a is contiguous with one end in the second direction Y (front end) of the first slope 220a. Each first contact portion 230a has a curve curved to the other side in the third direction Z (upper side). The first contact portion 230a of the one of the first contacts 200a is disposed above the housing space 102 of the body 100. The first contact portion 230a of the other first contact 200a is disposed above the housing space 101 of the body 100. These are initial positions of the first contact portions 230a. When the curves of the first contact portions 230a are subjected to an external force from the one side in the second direction Y (that is, when the curves of the first contact portions 230a are pressed from the one side in the second direction Y by a receptacle connector inserted into the connection port S), the external force moves the first contact portions 230a to the one side in the third direction Z (the fourth contact 300a side), i.e. from their initial positions to their moved positions (sec FIG. 4C). The first contact portion 230a of the one of the first contacts 200a at the moved position is received in the housing space 102. The first slope 220a of the one of the first contacts 200a is elastically deformable to the one side in the third direction Z (the fourth contact 300a side) inside the housing space 102 in accordance with the movement of the first contact portion 230a of the one of the first contacts 200a. The first contact portion 230a of the other first contact 200a at the moved position is received in the housing space 101. The first slope 220a of the other first contact 200a is elastically deformable to the one side in the third direction Z (the fourth contact 300a side) inside the housing space 101 in accordance with the movement of the first contact portion 230a of the other first contact 200a. In FIG. 4C, broken lines illustrates the first and second contact portions 230a and 230b of the first and second contacts 200a and 200b as moved to their moved positions and the first and second slopes 220a and 220b as elastically deformed accordingly.

Each first tail 240a is contiguous with the second end 212a of the first body 210a and protrudes from the rear section 130 of the body 100 to the other side in the second direction Y. Each first tail 240a includes a bent portion 241a and a connection portion 242a. The bent portion 241a is a substantially inverted-L-shaped plate contiguous with the second end 212a of the first body 210a. The connection portion 242a is a plate contiguous with the lower end of the bent portion 241a to extend to the other side in the second direction Y. The connection portion 242a is connectable to the cable or an electrode on the circuit board.

As best shown in FIG. 4C, the pair of second contacts 200b are metal plates of the same shape as the pair of first contacts 200a. The second contacts 200b are also mirror images of each other (see FIG. 4D and FIG. 4E). The second contacts 200b are next to each other at the first height along the first direction X. The second contacts 200b constitute a differential pair for transmitting high-speed differential signals of about 2.5 GHz. In other words, the second contacts 200b are signal contacts for differential signaling. As the second contacts 200b have the same shapes as the first contacts 200a, the second contacts 200b will be described only regarding the differences from the first contacts 200a. One of the pair of second contacts 200b will be referred to as one of the second contacts 200b, and the other as the other second contact 200b.

The second slope 220b of one of the second contacts 200b is housed in the housing space 104 of the body 100. The second contact portion 230b of one of the second contacts 200b is disposed above the housing space 104 of the body 100 so that the top of a curve of the second contact portion 230b are located at the same height as the tops of the curves of the first contact portions 230a. The second slope 220b of the other second contact 200b is housed in the housing space 105 of the body 100. The second contact portion 230b of the other second contact 200b is disposed above the housing space 105 of the body 100 so that the top of a curve of the second contact portion 230b is located at the same height as the tops of the curves of the first contact portions 230a. These are initial positions of the second contact portions 230b. When the curves of the second contact portions 230b are subjected to an external force from the one side in the second direction Y (that is, when the curves of the second contact portions 230b are pressed from the one side in the second direction Y by a receptacle connector inserted into the connection port S), the external force moves the second contact portions 230b to the one side in the third direction Z (the fourth contact 300a side), i.e. from their initial positions to their moved positions. The second contact portion 230b of one of the second contacts 200b at the moved position is received in the housing space 104. The second slope 220b of the one of the second contacts 200b is elastically deformable to the one side in the third direction Z (the fourth contact 300a side) inside the housing space 104 in accordance with the movement of the second contact portion 230b of the one of the second contacts 200b. The second contact portion 230b of the other second contact 200b at the moved position is received in the housing space 105. The second slope 220b of the other second contact 200b is elastically deformable to the one side in the third direction Z (the fourth contact 300a side) inside the housing space 105 in accordance with the movement of the second contact portion 230b of the other second contact 200b.

In FIG. 2A to FIG. 4E, 210b denotes a second body, 211b and 212b respectively denote first end second ends in the second direction Y of the second body, 240b denotes a second tail, and 241b and 242b respectively denote a bent portion and a connection portion of the second tail. The lower faces of the connection portions 242b arc located at the same height as the lower faces of the connection portions 242a.

The third contact 200c is a metal plate extending in the second direction Y to serve as a ground contact. As shown in FIG. 4D and FIG. 4E, the third contact 200c is disposed at a second height, between the one of the first contacts 200a and one of the second contacts 200b.

As best shown in FIG. 2B, the third contact 200c includes a third body 210c, a third slope 220c, a third contact portion 230c, and a third tail 240c. The third body 210c is a rectangular plate extending in the second direction Y and including first and second ends 211c and 212c in the second direction Y. The third body 210c is embedded in the middle section 120 and the rear section 130 of the body 100 an as to he located further to the one side in the third direction Z (closer to the fourth contact 300a side) than the first and second bodies 210a and 210b of the first and second contacts 200a and 200b are. The first end 211c of the third body 210c protrudes from the wall on the other side in the second direction Y of the recess 121 of the body 100. The third body 210c of the third contact 200c are referred to in the claims as the crosstalk reduction portion, and the first and second bodies 210a and 210b of the first and second contacts 200a and 200b respectively are referred to in the claims as the first and second corresponding portions, which correspond to the crosstalk reduction portion, of the first and second contacts 200a and 200b.

The third slope 220c is a plate contiguous with the first end 211c of the third body 210c to extend in the second direction Y. The third slope 220c is housed in the housing space 103 of the body 100. The first slope 220a slopes down to the one side in the third direction Z (the fourth contact 300a side). The angle of inclination of the third slope 220c is smaller than those of the first and second slopes 220a and 220b.

The third contact portion 230c has the same shape as the first and second contact portions 230a and 230b. The third contact portion 230c is disposed above the housing space 103 of the body 100 such that the top of the curve of the third contact portion 230c is located at the same height as the tops of the curves of the first and second contact portions 230a and 230b. This is the initial position of the third contact portion 230c. When the curve of the third contact portion 230c is subjected to an external force from the one side in the second direction Y (that is, when the curve of the third contact portion 230c is pressed from the one side in the second direction Y by a receptacle connector inserted into the connection port S), the external force moves the third contact portion 230c to the one side in the third direction Z (the fourth contact 300a side), i.e. from its initial position to its moved position. The third contact portion 230c at the moved position is received in the housing space 103. The third slope 220c is elastically deformable to the one side in the third direction Z (the fourth contact 300a side) inside the housing space 103 in accordance with the movement of the third contact portion 230c. In FIG. 4C, broken lines illustrates the third contact portion 230c of the third contact 200c as moved to its moved position and the third slope 220c as accordingly deformed elastically.

The third tail 240c has the same shape as the first tail 240a. Accordingly, the subelements of the third tail 240c will not be described in FIG. 1C, FIG. 2B, and FIGS. 4B, 241c and 242c respectively denote a bent portion and a connection portion of the third tail. The lower face of the connection portion 242c is located at the same height as the lower faces of the connection portions 242a and 242b.

As shown in FIG. 4A to FIG. 4E, the pair of fourth contacts 300a arc metal plates of the same shape extending in the second direction Y. One of the fourth contacts 300a is disposed at a third height between the one of the first contacts 200a and the third contact 200c. The third height is a different height from the first and second heights. The other fourth contact 300a is disposed at the third height, between the one of the second contacts 200b and the third contact 200c. That is, the pair of fourth contacts 300a is disposed at the third height, on both sides in the first direction X of the third contact 200c. The fourth contacts 300a constitute a differential pair for transmitting high-speed differential signals of about 240 MHz (i.e. the fourth contacts 300a are signal contacts for differential signaling).

As best shown in FIG. 2C, the fourth contacts 300a each include a fourth body 310a, a fourth slope 320a, a fourth separated portion 330a, a fourth contact portion 340a, and a fourth tail 350a.

The fourth body 310a is a rectangular plate extending in the second direction Y and including first and second ends 311a and 312a in the second direction Y. The fourth body 310a is embedded in the middle section 120 and the rear section 130 of the body 100. The fourth slope 320a is a plate contiguous with the first end 311a of the fourth body 310a to extend in the second direction Y to slope down to the one side in the third direction Z (lower side). The angle of inclination of the fourth slope 320a is larger than those of the first and second slopes 220a and 220b of the first and second contacts 200a and 200b. The fourth slope 320a of one of the fourth contacts 300a is embedded in the partition 142. The end faces in the first direction X of the fourth slope 320a of one of the fourth contacts 300a are exposed from the partition 142 (see FIG. 2B). The fourth slope 320a of the other fourth contact 300a is embedded in the partition 143. The end faces in the first direction X of the fourth slope 320a of the other fourth contact 300a are exposed from the partition 143 (see FIG. 2B).

Each fourth separated portion 330a is a substantially L-shaped plate contiguous with one end in the second direction Y (front end) of the fourth slope 320a. The fourth separated portion 330a includes a separated portion body 331a and a bent portion 332a. The separated portion body 331a of one of the fourth contacts 300a is a plate contiguous with the one end of the fourth slope 320a of the one of the fourth contacts 300a to extend in the second direction Y and embedded in the partition 142 and the front section 110 of the body 100. The end faces in the first direction X of the separated portion body 331a of one of the fourth contacts 300a are exposed from the partition 142 (see FIG. 2B). The separated portion body 331a of one of the fourth contacts 300a is disposed on the moving direction side (the one side in the third direction Z) of the first contact portion 230a of the one of the first contacts 200a and the third contact portion 230c of the third contact 200c. In other words, the one of the first contact portions 230a and the third contact portion 230c can move toward the separated portion body 331a of the one of the fourth contacts 300a. The separated portion body 331a of the other fourth contact 300a is a plate contiguous with the one end of the fourth slope 320a of the other fourth contact 300a to extend in the second direction Y and embedded in the partition 143 and the front section 110 of the body 100. The end faces in the first direction X of the separated portion body 331a of the other fourth contact 300a are exposed from the partition 143 (see FIG. 2B). The separated portion body 331a of the other fourth contact 300a is located on the moving direction side (the one side in the third direction Z) of the second contact portion 230b of the one of the second contacts 200b and the third contact portion 230c of the third contact 200c. That is, the one of the second contact portions 230b and the third contact portion 230c can move toward the separated portion body 331a of the other fourth contact 300a.

Each bent portion 332a is a plate contiguous with one end in the second direction Y (front end) of the separated portion body 331a, and it is bent at right angles to the separated portion body 331a to the other side in the third direction Z (upper side) to extend upward. The bent portion 332a is embedded in the front section 110 of the body 100.

Each fourth contact portion 340a is a plate contiguous with the upper end of the bent portion 332a of the fourth separated portion 330a, and it is bent at right angles to the bent portion 332a to the one side in the second direction Y (front side) to extend forward. Each fourth contact portion 340a includes a linear basal portion and a front portion stepping down from the basal portion. The fourth contact portions 340a are embedded in the front section 110 of the body 100. The upper face of the basal portion of the fourth contact portion 340a is exposed from the upper face of the front section 110 of the body 100.

Each fourth tail 350a is contiguous with the second end 312a of the fourth body 310a and protrudes from the rear section 130 of the body 100 to the other side in the second direction Y. The fourth tail 350a has a bent portion 351a and a connection portion 352a. The bent portion 351a is a plate contiguous with the second end 312a of the fourth body 310a and bent such that the lower face of the connection portion 352a is located at the same height as the lower faces of the connection portions 242a and 242b. The connection portion 352a is a plate contiguous with the lower end of the bent portion 351a to extend to the other side in the second direction Y. The connection portion 352a is connectable to a cable or an electrode on the circuit board.

The fifth contact 300b is a metal plate extending in the second direction Y to serve as a ground contact. As shown in FIG. 4A to FIG. 4E, the fifth contact 300b is located at the third height between the pair of first contacts 200a. The fifth contact 300b has substantially the same configuration as the fourth contacts 300a, except that its fifth contact portion 340b is different in shape from the fourth contact portions 340a of the fourth contacts 300a. Thus, subelements of the fifth contact 300b will be described only regarding the differences from those of the fourth contacts 300a.

As best shown in FIG. 2A, a fifth slope 320b is embedded in the partition 141 of the body 100. The end faces in the first direction X of the fifth slope 320b are exposed from the partition 141. A separated portion body 331b of a fifth separated portion 330b is embedded in the partition 141 and the front section 110 of the body 100. The end faces in the first direction X of the separated portion body 331b are exposed from the partition 141. The separated portion body 331b is located on the moving direction side (the one side in the third direction Z) of the first contact portions 230a of the pair of first contacts 200a. That is, the first contact portions 230a can move toward the separated portion body 331b. As shown in FIGS. 3A, 4D, and 4E, the basal portion of the fifth contact portion 340b has a larger dimension in the second direction Y than the basal portion of the fourth contact portion 340a, and the front portion of the fifth contact portion 340b has a smaller dimension in the second direction Y than the front portion of the fourth contact portion 340a. in FIG. 2A, FIG. 3A to FIG. 4E, 310b denotes a fifth body of the fifth contact, 311b denotes a first end in the second direction of the fifth body, 312b denotes a second end in the second direction of the fifth body, 332b denotes a bent portion of the fifth separated portion, 350b denotes a fifth tail of the fifth contact, 351b denotes a bent portion of the fifth tail, and 352b denotes a connection portion of the fifth tail.

The sixth contact 300c is a metal plate extending in the second direction Y to serve as a Vbus contact. As shown in FIG. 4A to FIG. 4E, the sixth contact 300c is disposed at the third height between the pair of second contacts 200b. The sixth contact 300c has the same configuration as the fifth contact 300b, except that the sixth contact 300c is a mirror image of the fifth contact 300b. Thus, subelements of the sixth contact 300c will be described only regarding the differences from those of the fifth contact 300b.

A sixth slope 320c is embedded in the partition 144 of the body 100. The end faces in the first direction X of the sixth slope 320c are exposed from the partition 144. A separated portion body 331c of a sixth separated portion 330c is embedded in the partition 144 and the front section 110 of the body 100. The end faces in the first direction X of the separated portion body 331c are exposed from the partition 144. The separated portion body 331c is located on the moving direction side (the one side in the third direction Z) of the second contact portions 230b of the pair of second contacts 200b. That is, the second contact portions 230b can move toward to the separated portion body 331c. In FIG. 3A to FIG. 4E, 310c denotes a sixth body of the sixth contact, 311c denotes a first end in the second direction of the sixth body, 312c denotes a second end in the second direction of the sixth body, 332c denotes a bent portion of the sixth separated portion, 340c denotes a sixth contact portion of the sixth contact, 350c denotes a sixth tail of the sixth contact, 351c denotes a bent portion of the sixth tail, and 352c denotes a connection portion of the sixth tail.

D in FIG. 4C and FIG. 4D refers to a distance between the separated portion body 331b of the fifth separated portion 330b of the fifth contact 300b and the proximal portion of the curve of the first contact portion 230a of each first contact 200a as located at (moved to) its moved position, and also a distance between the separated portion body 331c of the sixth separated portion 330c of the sixth contact 300c and the proximal portion of the curve of the second contact portion 230b of each second contact 200b as located at (moved to) its moved position. The distance D is set such that impedance of each of the first and second contacts 200a and 200b varies in a range of 75 Ω to 105 Ω in accordance with the movement of the first, second, and third contact portions 230a, 230b, and 230c from their initial positions to their moved positions. This arrangement means that there is a large distance between the separated portion body 331b of the fifth separated portion 330b and each first contact portion 230a as located at its moved position, and that there is a large distance between the separated portion body 331c of the sixth separated portion 330c and each second contact portion 230b as located at its moved position. These large distances serves to suppress impedance variations of the first and second contacts 200a and 200b to the above-mentioned range when the first, second, and third contact portions 230a, 230b, and 230c move closer to the separated portion bodies 331a, 331b, and 331c. It should he appreciated that the moved position of each first contact portion 230a is a position where each first contact portion 230a is at the distance D in the third direction Z from the separated portion body 331b. The moved positions of the second and third contact portions 230b and 230c are set in the same manner as the moved position of the first contact portion 230a. The tops of the curves of the first, second, and third contact portions 230a, 230b, and 230c of the first, second, and third contacts 200a, 200b, and 200c at the moved positions are located above the upper faces (faces on the other side in the third direction Z) of the fourth, fifth, and sixth contact portions 340a, 340b, 340c of the fourth, fifth, and sixth contacts 300a, 300b, and 300c (see FIG. 4C).

The connector configured as described below may be assembled in the steps as described below in detail. First, a metal plate is prepared. The metal plate is pressed to form at a time the pair of first contacts 200a, the pair of second contacts 200b, the third contact 200c, the pair of fourth contacts 300a, the fifth contact 300b, and the sixth contact 300c. The tails of the first, second, and third contacts 200a, 200b, and 200c and of the fourth, fifth, and sixth contacts 300a, 300b, and 300c are connected to a first carrier (not shown). The contact portions of the fourth, fifth, and sixth contacts 300a, 300b, and 300c are connected to a second carrier (not shown).

Then, the body 100 is molded with the first, second, and third contacts 200a, 200b, and 200c, and the fourth, fifth, and sixth contacts 300a, 300b, and 300c inserted therein. The first, second, and third bodies 210a, 210b, and 210c of the first, second, and third contacts 200a, 200b, and 200c are thus embedded in the body 100 at intervals along the first direction X. The first slopes 220a and the first contact portions 230a of the first contacts 200a are received in the housing spaces 101 and 102 of the body 100. The second slopes 220b and the second contact portions 230b of the second contacts 200b are received in the housing spaces 104 and 105 of the body 100. The third slope 220c and the third contact portion 230c of the third contact 200c are received in the housing space 103 of the body 100. The first, second, and third tails 240a, 240b, and 240c of the first, second, and third contacts 200a, 200b, and 200c protrude rearward from the body 100. Also, portions excluding the fourth tails 350a of the fourth contacts 300a (i.e. the fourth bodies 310a, the fourth slopes 320a, the fourth separated portions 330a, and the fourth contact portions 340a), portions excluding the fifth tail 350b of the fifth contact 300b (i.e. the fifth body 310b, the fifth slope 320b, the fifth separated portion 330b, and the fifth contact portion 340b), and portions excluding the sixth tail 350c of the sixth contact 300c (i.e. the sixth body 310c, the sixth slope 320c, the sixth separated portion 330c, and the sixth contact portion 340c) are embedded in the body 100 at intervals along the first direction X. The first and second contacts 200a and 200b are thus held in the body 100 so as to align at the first height along the first direction X, and the third contact 200c is held in the body 100 so as to be located at the second height between the one of the first second contacts 200a and the one of the second contacts 200b. The fifth contact 300b, the fourth contact 300a, the fourth contact 300a, and the sixth contact 300c are held in this order at intervals along the first direction X, at the third height below (on the one side in the third direction Z of) the first, second, and third contacts 200a, 200b, and 200c of the body 100. After that, the first and second carriers are removed.

Subsequently, the body 100 is inserted into the shell 400. Then, the first engagement piece 412 of the shell 400 is brought into engagement with the engagement recess 131 of the body 100, and the second engagement pieces 413 with the engagement recess of the body 100.

The connector thus assembled is connected to a cable, or a cable via a circuit board. Described below are steps of connecting the connector to a cable via a circuit board. First, the connection pieces 420 of the shell 400 are inserted into through-hole ground electrodes in the circuit board. These electrodes in the circuit board are thus contacted by the first, second, and third tails 240a, 240b, and 240c of the first, second, and third contacts 200a, 200b, and 200c and the fourth, fifth, and sixth tails 350a, 350b, and 350c of the fourth, fifth, and sixth contacts 300a, 300b, and 300c. In this state, the connection pieces 420 are soldered to the through-hole electrodes. The first, second, third, fourth, fifth tails 240a, 240b, 240c, 350a, 350b, and 350c are soldered to the respective electrodes. The circuit board is to be connected to a cable, so that the connector is connected to the cable via the circuit board.

The above-described connector has at least the following technical features. First, it is possible to reduce crosstalk between the first and second contacts 200a and 200b, and the fourth contacts 300a for the following reasons. Signals leaking from the first contacts 200a will be absorbed by the fifth contact 300b, and signals leaking from the second contacts 200b will be absorbed by the sixth contact 300c. Moreover, the third contact 200c, disposed between the one of the first contacts 200a and the one of the second contacts 200b, includes the third body 210c (crosstalk reduction portion) that is located closer to the fourth contact 300a than the first and second bodies 210a and 210b (first and second corresponding portions) of the first and second contacts 200a and 200b are. Therefore, signals leaking from the fourth bodies 310a of the fourth contacts 300a will be absorbed by the third body 210c, thereby preventing such leaking signals from being absorbed by the first body 210a of the one of the first contacts 200a and/or by the second body 210b of the one of the second contacts 200b.

Second, impedances can be matched between the first contacts 200a and between the second contacts 200b during the movement of their first, second, and third contact portions 230a, 230b, and 230c of the first, second, and third contacts 200a, 200b, and 200c. This is because the distance D is set such that impedance of each of the first and second contacts 200a and 200b varies in the range of 75 Ω to 105 Ω when the first, second, and third contact portions 230a, 230b, and 230c move from their initial positions to the their moved positions. This arrangement can suppress impedance variations of the first and second contacts 200a and 200b to the range of 75 Ω to 105 Ω when the curves of the first, second, and third contact portions 230a, 230b, and 230c are pressed by the receptacle connector and move from their initial positions to their moved positions to be closer to the separated portion bodies 331a, 331b, and 331c.

The connector is not limited to the embodiment and may be modified in any manner within the scope of the claims as described below in detail.

In the above embodiment, the pair of first contacts 200a and the pair of second contacts 200b are provided in the body 100 to be next to each other at the first height along the first direction X. and each pair constitutes a differential pair. However, at least one first contact and at least one second contact may be provided to align along the first direction at the first height.

In the above embodiment, the first contacts 200a each include the first body 210a, the first slope 220a, the first contact portions 230a, and the first tails 240a, and the second contacts 200b each include the second body 210b, the second slope 220b, the second contact portions 230b, and the second tails 240b. However, the first and second contacts may be modified in any manner as long as a first contact and a second contact respectively have a first corresponding portion and a second corresponding portion corresponding to a crosstalk reduction portion of a third contact. For example, a first contact and a second contact may respectively include a first corresponding portion and a second corresponding portion corresponding to the crosstalk reduction portion of the third contact, and a first contact portion and a second contact portion may be disposed at the same height as that of a third contact portion of a third contact, and the first and second contact portions may be movable toward a fourth contact or contacts resulting from partial elastic deformation of the first and second contacts under an external force. The pair of first contacts may have the same shape or different shapes, and the pair of second contacts may have the same shape or different shapes.

In the above embodiment, the third contact 200c is disposed between the one of the first contacts 200a and the one of the second contacts 200b. However, the third contact may be disposed anywhere at the second height between a first contact and a second contact. The second height may be the same as or different from the first height. In the above embodiment, the third contact includes the third body 210c serving as the crosstalk reduction portion, the third slope 220c, the third contact portion 230c, and the third tail 240c. However, the third contact may be modified in any manner as long as it has a crosstalk reduction portion that is located closer to a fourth contact than the first and second corresponding portions are. That is, the crosstalk reduction portion may be any position of the third contact. The third contact may include a crosstalk reduction portion and a third contact portion movable toward the fourth contacts resulting from partial elastic deformation of the third contact under an external force.

In the above embodiment, the first, second, and third contact portions 230a, 230b, and 230c of the first, second, and third contacts 200a, 200b, and 200c can move from their respective initial positions to their moved positions toward the fourth contacts 300a. However, the first, second, and third contact portions of the first, second, and third contacts may be fixed to the body. In other words, the first, second, and third contact portions may be kept in position even under an external force due to insertion of a mating connector into a connection port of the connector. In this case, the first, second, and third slopes of the first, second, and third contacts may be omitted so that the first, second, and third contacts respectively include only the first, second, and third bodies, the first, second, and third contact portions, and the first, second, and third tails. If not omitted, the first, second, and third slopes may he embedded in the body. In this case, the first, second, and third slopes do not elastically deform.

In the above embodiment, one of the fourth contacts 300a is disposed at the third height between the one of the first contacts 200a and the third contact 200c, and the other fourth contact 300a is disposed at the third height between one of the second contacts 200b and the third. contact 200c. However, each fourth contact may be modified in any manner as long as it is disposed at the third height on one of the sides in the first direction X of the third contact and the third height is different from the first and second heights. Thus, the fourth contacts need not constitute a differential pair. A fourth contact may be disposed at the third height, between a first contact and the third contact, or between a second contact and the third contact. The fourth contact may be disposed at the third height on a vertical line of one of the first and second contacts. The pair of fourth contacts may be disposed at the third height on the respective vertical lines of the first and second contacts. The fourth contacts may be of any shape. For example, each fourth contact may include a fourth body, a fourth contact portion, and a fourth separated portion that is located on a moving direction side of the first, second, and third contact portions that are movable toward the fourth separated portion. Each fourth contact may include a fourth body, a fourth contact portion, and a fourth tail. Accordingly, the fourth separated portion may be omitted.

In the above embodiment, the distance D is a distance between the separated portion body 331b of the fifth separated portion 330b of the fifth contact 300b and the proximal portion of the curve of the first contact portion 230a of the first contact 200a as located at its moved position, and also a distance between the separated portion body 331c of the sixth separated portion 330c of the sixth contact 300c and the proximal portion of the curve of the second contact portion 230b of the second contacts 200b as located at its moved position. However, the distance D may be any distance between each first contact portion as moved and the fifth separated portion that is configured such that impedance of each first contact varies in a range of 75 Ω to 105 Ω in accordance with the movement of the first, second, and third contact portions, and also any distance between each second contact portion as moved and the sixth separated portion that is configured such that impedance of each second contact varies in a range of 75 Ω to 105 Ω in accordance with the movement of the first, second, and third contact portions.

In the above embodiment, the connector includes the fifth and sixth contacts 300b, 300c. However, the fifth and sixth contacts may be omitted. The fifth and sixth contacts may have the same shape as or different shapes from the fourth contacts. For example, the fifth and sixth contacts may be modified in shape in a similar manner to the fourth contacts. The fifth and sixth contacts may each have a shape of cross section in the second direction corresponding to that of each fourth contact and have a shape of cross section in the first direction at least partially corresponding to that of each fourth contact. The fifth contact may be used as a contact other than a ground contact. For example, the fifth contact may be used as a contact for lower speed signaling than the first and second contacts, or as a Vbus contact. The sixth contact may be used as a contact other than a Vbus contact. For example, the sixth contact may be used as a contact for lower speed signaling than the first and second contacts, or as a ground contact.

In the above embodiment, the first, second, third, fourth, fifth, and sixth tails protrude from the body 100 to the other side in the second direction Y (rear side) for connection with a cable or to a cable through a circuit board. However, the first, second, third, fourth, fifth, and sixth tails are not limited to these. For example, the first, second, third, fourth, fifth, and sixth tails may protrude from the body 100 to the other side in the second direction Y (rear side) to be mounted on respective electrodes on a circuit board. The first, second, third, fourth, fifth, and sixth tails may hang from the body to the one side in the third direction for connection with through-hole electrodes in a circuit board. These types of circuit boards may not be connected to a cable. In other words, the connector of the invention may be adapted to be a plug connector and a receptacle connector mountable on a circuit board.

In the above embodiment, the fourth, fifth, and sixth separated portions each have a separated portion body and a bent portion. However the fourth, fifth, and sixth separated portions may be modified in any manner as long as they each have at least a separated portion body. For example, the fourth, fifth, and sixth contact portions may be contiguous with the respective separated portion bodies of the fourth, fifth, and sixth separated portions. In the above embodiment, the bent portions of the fourth, fifth, and sixth separated portions are bent at right angles to the respective separated portion bodies, but they may slope relative to the respective separated portion bodies or may be bent into a stepped shape.

In the above embodiment, the body 100 includes the front section 110, the middle section 120, and the rear section 130. However, the body may be modified in any manner as long as it is adapted to hold first and second contacts aligned at a first height along the first direction, a third contact at a second height between the first and second contacts, and a fourth contact at a third height, which is different from the first and second heights, to be located on at least one of the sides in the first direction of the third contact. For example, the first, second, third, and fourth contacts may be press-fitted into respective through holes extending in the second direction through the body. The fifth and sixth contacts may also be press-fitted into respective through boles extending in the second direction through the body. Any of the first, second, third and fourth contacts may be embedded in the body, and the remaining contact(s) may be press-fitted into through hole(s) in the body.

The body may be provided with, in place of the recesses 111 and 112, other kind of recess(es) that do not extend in the third direction through the body. In this case, the first, second, and third contact portions of the first, second, and third contacts may move from their initial positions to their moved positions in the other kind of recess(es). The initial positions and the moved positions of the first, second, and third contact portions may be any positions and are not limited to the ones according to the embodiment. The moved positions may be any positions to which the first, second, and third contact portions have moved from the initial positions toward the fourth separated portion.

The partitions 141, 142, 143, and 144 may be omitted. The partitions may be provided in the aforementioned other recess(es) of the body.

In the above embodiment, the shell 400 surrounds the body 100. However, the shell may be omitted. The shell may be modified in any manner as long as it can surround the body. That is, the connection pieces 420 may be omitted.

The materials, shapes, dimensions, numbers, and arrangements of the components constituting the connector of the above embodiment are described by way of examples only, and they may be modified in any manner as long as they can achieve similar functions. In the above embodiment, the first contact group is designed for USB 3.0, and the second contact group is designed for USB 2.0. However, the first and second contact groups may comply with any other standards than USB standards. The embodiment and the modifications described above may be combined in any possible manner.

### REFERENCE SIGNS LIST

100: body
110: front section
120: middle section
130: rear section

200a: first contact
210a: first body (first corresponding portion)
   211a: first end
   212a: second end
220a: first slope
230a: first contact portion
240a: first tail

200b: second contact
210b: second body (second corresponding portion)
   211b: first end
   212b: second end
220b: second slope
230b: second contact portion
240b: second tail

200c: third contact
210c: third body (crosstalk reduction portion)
   211c: first end
   212c: second end
220c: third slope
230c: third contact portion
240c: third tail

300a: fourth contact
310a: fourth body
   311a: first end
   312a: second end
320a: fourth slope
330a: fourth separated portion
340a: fourth contact portion
350a: fourth tail

300b: fifth contact
310b: fifth body
   311b: first end
   312b: second end
320b: fifth slope
330b: fifth separated portion
340b: fifth contact portion
350b: fifth tail

300c: sixth contact
310c: sixth body
   311c: first end
   312c: second end
320c: sixth slope
330c: sixth separated portion
340c: sixth contact portion
350c: sixth tail

400: shell

X: first direction

Y: second direction

Z: third direction

1. A connector comprising:
a body having an insulating property;
first and second contacts serving as signal contacts, being aligned at a first height along a first direction in the body;
a third contact serving as a ground contact, being provided at a second height between the first and second contacts in the body; and
a fourth contact serving as a signal contact, being provided at a third height in the body to be located on one of sides in the first direction of the third contact, the third height being a different height from the first and second heights, wherein
the third contact includes a crosstalk reduction portion,
the first and second contacts respectively include first and second corresponding portions corresponding to the crosstalk reduction portion, and
the crosstalk reduction portion is located closer to the fourth contact than the first and second corresponding portions are.

2. The connector according to claim 1, wherein
the first contact comprises a pair of first contacts disposed next to each other at the first height along the first direction,
the second contact comprises a pair of second contacts disposed next to each other at the first height along the first direction, and
the third contact is disposed between one of the first contacts and one of the second contacts.

3. The connector according to claim 2, wherein
the fourth contact comprises a pair of fourth contacts disposed at the third height on the respective sides in the first direction of the third contact, and
one of the fourth contacts is disposed at the third height between the one of the first contacts and the third contact, and the other fourth contact is disposed at the third height between the one of the second contacts and the third contact.

4. The connector according to claim 3, further comprising:
a fifth contact provided at the third height between the first contacts in the body; and
a sixth contact provided at the third height between the second contacts in the body.

5. The connector according to claim 4, wherein
the third contact further includes a third contact portion movable toward the fourth contacts resulting from partial elastic deformation of the third contact under an external force,
each of the first contacts and each of the second contacts further include first and second contact portions, respectively, disposed at the same height as the third contact portion of the third contact, the first and second contact portions being movable toward the fourth contacts resulting from partial elastic deformation of the first and second contacts under an external force,
the one of the fourth contacts includes a fourth separated portion located on a moving direction side of the first and third contact portions, the first and third contact portions being movable toward the fourth separated portion,
the other fourth contact includes a fourth separated portion located on a moving direction side of the second and third contact portions, the second and third contact portions being movable toward the fourth separated portion of the other fourth contact,
the fifth contact includes a fifth separated portion located on the moving direction side of the first contact portions, the first contact portions being movable toward the fifth separated portion,
the sixth contact includes a sixth separated portion located on the moving direction side of the second contact portions, the second contact portions being movable toward the sixth separated portion,
a distance between each of the first contact portions as moved and the fifth separated portion is such that impedance of each of the first contacts varies in a range of 75 Ω to 105 Ω in accordance with the movement of the first, second, and third contact portions, and
a distance between each of the second contact portions as moved and the sixth separated portion is such that impedance of each of the second contacts varies in a range of 75 Ω to 105 Ω in accordance with the movement of the first, second, and third contact portions.

6. The connector according to claim 4, wherein
the third contact includes:
a third body serving as the crosstalk reduction portion, being held in the body and including first and second ends in a second direction, the second direction being orthogonal to the first direction;
a third slope being contiguous with the first end of the third body and sloping toward the fourth contacts;
a third contact portion being contiguous with the third slope; and
a third tail being contiguous with the second end of the third body and protruding from the body,
the first contacts each include:
a first body serving as the first corresponding portion, being held in the body and including first and second ends in the second direction;
a first slope being contiguous with the first end of the first body and sloping toward the fourth contacts;
a first contact portion being contiguous with the first slope and located at the same height as the third contact portion of the third contact; and
a first tail being contiguous with the second end of the first body and protruding from the body, and
the second contacts each include:
a second body serving as the second corresponding portion, being held in the body and including first and second ends in the second direction;
a second slope being contiguous with the first end of the second body and sloping toward the fourth contacts;
a second contact portion being contiguous with the second slope and located at the same height as the third contact portion of the third contact; and
a second tail being contiguous with the second end of the second body and protruding from the body.

7. The connector according to claim 6, wherein
the first, second, and third slopes are elastically deformable toward the fourth contacts when the first, second, and third contact portions under an external force move toward the fourth contacts,
the one of the fourth contacts includes:
a fourth body being held in the body and including first and second ends in the second direction;
a fourth slope being contiguous with the first end of the fourth body and sloping in the same direction as the first and second slopes;
a fourth separated portion being contiguous with the fourth slope, extending in the second direction, and being located on the moving direction side of the first and third contact portions, the first and third contact portions being movable toward the fourth separated portion;
a fourth contact portion being contiguous with the fourth separated portion; and
a fourth tail being contiguous with the second end of the fourth body and protruding from the body,
the other fourth contact includes;
a fourth body being held in the body and including first and second ends in the second direction;
a fourth slope being contiguous with the first end of the fourth body of the other fourth contact and sloping in the same direction as the first and second slopes;
a fourth separated portion being contiguous with the fourth slope of the other fourth contact, extending in the second direction, and being located on the moving direction side of the second and third contact portions, the second and third contact portions being movable toward the fourth separated portion of the other fourth contact;
a fourth contact portion being contiguous with the fourth separated portion of the other fourth contact; and
a fourth tail being contiguous with the second end of the fourth body of the other fourth contact and protruding from the body,
the fifth contact includes:
a fifth body being held in the body and including first and second ends in the second direction;
a fifth slope being contiguous with the first end of the fifth body and sloping in the same direction as the first and second slopes;
a fifth separated portion being contiguous with the fifth slope, extending in the second direction, and being located on the moving direction side of the first contact portions, the first contact portions being movable toward the fifth separated portion;
a fifth contact portion being contiguous with the fifth separated portion; and
a fifth tail being contiguous with the second end of the fifth body and protruding from the body,
the sixth contact includes:
a sixth body being held in the body and including and second ends in the second direction;
a sixth slope being contiguous with the first end of the sixth body and sloping in the same direction as the first and second slopes; and
a sixth separated portion being contiguous with the sixth slope, extending in the second direction, and being located on the moving direction side of the second contact portions, the second contact portions being movable toward the sixth separated portion;
a sixth contact portion being contiguous with the sixth separated portion; and
a sixth tail being contiguous with the second end of the sixth body and protruding from the body,
a distance between each of the first contact portion as moved and the fifth separated portion is set such that impedance of each of the first contacts varies in a range of 75 Ω to 105 Ω in accordance with the movement of the first, second, and third contact portions, and
a distance between each of the second contact portion as moved and the sixth separated portion is set such that impedance of each of the second contacts varies in a range of 75 Ω to 105 Ω in accordance with the movement of the first, second, and third contact portions.
